(19) United States
(12) Patent Application Publication
(10) Pub. No.: US 2011/0037384 A1
(43) Pub. Date: Feb. 17, 2011

(54) Plasma display panel

(76) Inventors: Goon-Ho Kim, Suwon-si (KR); Woo-Joon Chung, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/801,714

(22) Filed: Jun. 22, 2010

(30) Foreign Application Priority Data
Aug. 17, 2009 (KR) 10-2009-0075669

(51) Int. Cl. H01J 17/49

(52) U.S. Cl. 313/585

(57) ABSTRACT

A plasma display panel comprises: a first substrate having a first side; a second substrate having a second side facing the first side of the first substrate; address electrodes, each extending in a first direction; sustain electrodes, each extending in a second direction crossing the first direction; sets of a first scan electrode and a second scan electrode, the sets and the sustain electrodes positioned alternately; first partitions, each extending in the second direction; and second partitions, each extending in the first direction. The second partitions and the address electrodes are positioned alternately. Each of the first and second scan electrodes has a line width narrower than a line width of each of the sustain electrodes. Each of the sets of the first scan electrode and the second scan electrode are positioned on a central region of a discharge cell. Each of the sustain electrodes overlaps each of the partitions.

### BACKGROUND

1. Field

Embodiments relate to a plasma display panel, and more particularly, to a plasma display panel for reducing a discharge voltage and for reducing address time.

2. Description of the Related Art

A plasma display panel (PDP) displays an image by using ultraviolet rays of 147 nm which are generated during discharge of inert gas mixture to make a fluorophore emit light. The PDP is easily made thin and large in size, and displays a remarkably enhanced quality of image due to recent technical developments.

The PDP may be roughly divided into a panel unit and a driving unit. The panel unit includes an electrode assembly positioned between a pair of substrates facing each other, an insulator that electrically insulates electrodes included in the electrode assembly, partitions that form discharge spaces between the pair of substrates, and a fluorophore that is disposed in the discharge space and emits light due to discharge. The panel unit includes a plurality of discharge cells arranged in a matrix form.

The driving unit includes a sustain driving unit, a scan driving unit, an address driving unit, and a timing controlling unit that controls the driving units. The driving units supply predetermined voltages to the electrodes in response to data fed from the outside so that an image is displayed on the panel unit.

A design of the discharge cells may be roughly divided into two types in view of an electrode structure and a partition design. One type of the design is a simple rectangular partition structure, and the other type is a dual partition structure.

A discharge cell having the simple rectangular partition structure can have a discharge space wider than that of a discharge cell having the dual partition structure. Accordingly, brightness per discharge of the discharge cell having the simple rectangular partition structure is higher than that of the discharge cell having the dual partition structure. However, since an emitting region is generally screened by a bus electrode, the simple rectangular partition structure has a lower aperture ratio than the dual partition structure.

The discharge cell having the dual partition structure is designed so that a bus electrode overlaps the partition. Accordingly, the dual partition structure has a higher aperture ratio than the simple rectangular partition structure. However, the discharge cell having the dual partition structure has a smaller discharge space than the discharge cell having the simple rectangular partition structure. Accordingly, brightness per discharge of the discharge cell having the dual partition structure is lower than that of the discharge cell having the simple rectangular partition structure.

### SUMMARY

Embodiments are therefore directed to a PDP, which substantially overcome one or more of the problems due to the limitations and disadvantages of the related art.

It is therefore a feature of an embodiment to provide a PDP capable of being driven by a low voltage by maximizing a discharge space.

It is therefore another feature of an embodiment to provide a PDP comprising: a first substrate having a first side; a second substrate having a second side facing the first side of the first substrate; address electrodes, each extending in a first direction; sustain electrodes, each extending in a second direction crossing the first direction; sets of a first scan electrode and a second scan electrode, the sets and the sustain electrodes positioned alternately, each of the first and second scan electrodes having a line width narrower than a line width of each of the sustain electrodes; first partitions, each extending in the second direction, each of the sustain electrodes overlapping each of the partitions; and second partitions, each extending in the first direction, the second partitions and the address electrodes positioned alternately, wherein each of the sets of the first scan electrode and the second scan electrode are positioned on a central region of a discharge cell, and wherein the first scan electrodes, the second scan electrodes, and the sustain electrodes are formed on the second side of the second substrate, and address electrodes are formed on the first side of the first substrate.

Each of the first bus electrodes may overlap each of the first partitions.

At least one of the above and other features and advantages may also be realized by providing a plasma display panel comprising: a first substrate having a first side; a second substrate having a second side facing the first side of the first substrate; address electrodes, each extending in a first direction; sustain electrodes, each extending in a second direction crossing the first direction; sets of a first scan electrode and a second scan electrode, the sets and the sustain electrodes positioned alternately, each of the first and second scan electrodes having a line width narrower than a line width of each of the sustain electrodes; first partitions, each extending in the second direction and positioned between the first scan electrode and the second scan electrode in each of the sets; second partitions, each extending in the first direction, and the second partitions and the address electrodes positioned alternately, wherein the first scan electrodes, the second scan electrodes, and the sustain electrodes are formed on the second side of the second substrate and address electrodes are formed on the first side of the first substrate.

Each of the sustain electrodes may cause sustain discharge with a first scan electrode positioned at a side of each sustain electrode and a second scan electrode positioned at the other side of each sustain electrode.

Each of the sustain electrodes may comprise: a third transparent electrode; and a third bus electrode positioned on a central region of the third transparent electrode.

Each of the third bus electrodes may have a line width equal to or narrower than a width of each of the first partitions.

Each of the first scan electrodes may comprise: a first transparent electrode having a line width narrower than a line width of each of the third transparent electrodes; and a first bus electrode disposed on a first edge portion of the first transparent electrode, the first edge portion positioned at a side of a sustain electrode that is positioned at a side of each of the first scan electrode.

The first bus electrodes, the second bus electrodes, and the third electrodes may be sequentially disposed at an equal interval.

The plasma display panel may further comprise a black matrix formed between a first scan electrode and a second scan electrode in each of the sets.

Each of the sustain electrodes may cause sustain discharge with a first scan electrode positioned at a side of each sustain electrode and a second scan electrode positioned at the other side of each sustain electrode.

Accordingly, the embodiments have been made to provide a PDP capable of being driven by a low voltage by maximizing a discharge space.

The embodiments also provide a PDPP including a cell structure having an aperture ration higher than a PDP including a simple rectangular partition structure and a wider discharge space than a PDP including a dual partition structure.

According to the embodiments, the address discharge delay of the discharge cells that are currently positioned on the horizontal line may be reduced by priming charged particles generated from the discharge cells that are positioned on the horizontal line. In addition, according to the embodiments, a wider discharge space may be obtained so that address voltage and sustain voltage may be reduced.

According to the embodiments, a higher aperture ratio than those of discharge cells of a simple rectangular partition structure and of a dual partition structure may be obtained.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 is a schematic view illustrating a PDP according to the exemplary embodiments;

FIG. 2 is a sectional view illustrating the PDP according to a first embodiment;

FIG. 3 is a plan view illustrating the PDP illustrated in FIG. 2;

FIG. 4 is a plan view illustrating a PDP according to a second embodiment;

FIG. 5 is a plan view illustrating a PDP according to a third embodiment; and

FIG. 6 is a graph presenting the relationship between the driving time and the address discharge delay according to priming charged particles.

### DETAILED DESCRIPTION

Korean Patent Application No. 10-2009-0075669, filed on Aug. 17, 2009, in the Korean Intellectual Property Office, and entitled: “Plasma Display Panel,” is incorporated by reference herein in its entirety.

In the following detailed description and the drawings, only certain exemplary embodiments have been shown and described. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Hereinafter, like reference numerals refer to like elements.

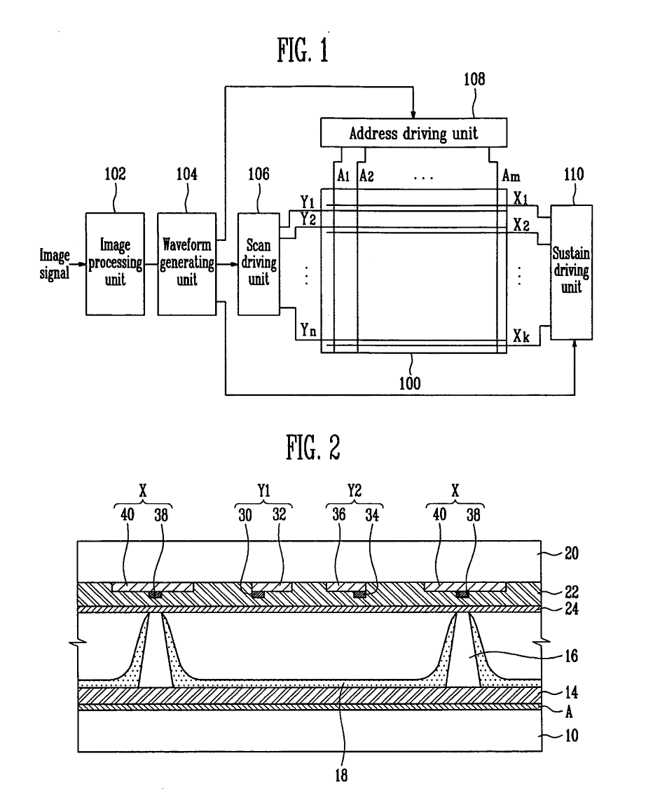

FIG. 1 is a schematic view illustrating a PDP according to the exemplary embodiments.

Referring to FIG. 1, a PDP may include a panel 100, an address driving unit 108, a scan driving unit 106, a sustain driving unit 110, a waveform generating unit 104, and an image processing unit 102.

The image processing unit 102 may receive an analog image signal from the outside. The image processing unit 102 may convert the received analog image signal into a digital image signal. In addition, the image processing unit 102 may generate a vertical synchronizing signal, a horizontal synchronizing signal, and a clock signal, and supply the generated signals to the waveform generating unit 104.

The waveform generating unit 104 may receive the digital image signal, the vertical synchronizing signal, the horizontal synchronizing signal, and the clock signal. The waveform generating unit 104 may divide the received digital image signal according to the sub-fields, and supply the divided digital image signal to the address driving unit 108. In addition, the waveform generating unit 104 may generate control signals to correspond to the vertical synchronizing signal, the horizontal synchronizing signal, and the clock signal, respectively. The waveform generating unit 104 may supply the generated control signals to the scan driving unit 106, the address driving unit 108, and the sustain driving unit 110.

The address driving unit 108 may generate a data signal in response to the image signal and the control signal supplied to the address driving unit. The address driving unit 108 may supply the generated data signal to address electrodes A1 to Am for an address period of each sub-field.

The scan driving unit 106 may generate a scan signal in response to the control signal supplied to the scan driving unit 106. The scan driving unit 106 may supply the generated scan signal to scan electrodes Y1 to Yn for the address period of each sub-field. In addition, the scan driving unit 106 may supply lamp pulses to the scan electrode Y1 to Yn for a reset period of each sub-field, and supply sustain pulses for a sustain period.

The sustain driving unit 110 may supply the sustain pulses to sustain electrodes X1 to Xk and the scan electrode Y1 to Yn alternately for the sustain period in response to the control signals which are supplied to the sustain driving unit 110.

FIG. 2 is a sectional view illustrating a PDP according to the first embodiment.

Referring to FIG. 2, the PDP according to the first embodiment may include an upper substrate 20, a lower substrate 10, scan electrodes Y1 and Y2 and sustain electrodes X that are formed on the rear side of the upper substrate 20, and address electrodes A that are formed on a first side of the lower substrate 10. The rear side of the upper substrate 20 faces the first side of the lower substrate.

A set of a first scan electrode Y1 and a second scan electrode Y2 may be formed between two sustain electrodes X.

The first scan electrode Y1 may include a first transparent electrode 32 and a first bus electrode 30. The first bus electrode 30 may have a line width narrower than that of the first transparent electrode 32. The first bus electrode 30 may be formed on a first edge portion of the first transparent electrodes 32. The first edge portion is positioned at a side of a sustain electrode X that is positioned at a side of the first scan electrode Y1.

The second scan electrode Y2 may include a second transparent electrode 36 and a second bus electrode 34. The second bus electrode 34 may have a line width narrower than that of the second transparent electrode 36. The second bus electrode 34 may be formed on a second edge portion of the second transparent electrode 36. The second edge portion is positioned at a side of a sustain electrode X that is positioned at a side of the second scan electrode Y2.

Each sustain electrode X may include a third transparent electrode 40 and a third bus electrode 38. The third bus electrode 38 may have a narrower line width than that of the third transparent electrode 40. The third bus electrode 38 is positioned on the central area of the third transparent electrode 40.

The first, second, and third transparent electrodes 32, 36, and 40 may be made of transparent material such as indium-tin-oxide (ITO). The first, second, and third transparent electrodes 32, 36, and 40 may be formed on the rear side of the upper substrate 20. The first, second, and third bus electrodes 30, 34, and 38 may be made of metal material such as chromium (Cr). The first, second, and third bus electrodes 30, 34, and 38 may be formed on the rear sides of the transparent electrodes 32, 36, and 40, respectively. The first, second, and third bus electrodes 30, 34, and 38 may reduce voltage drop of the first, second, and third transparent electrodes 32, 36, and 40 with high resistance, respectively.

An upper dielectric layer 22 and a protective layer 24 may be sequentially laminated on the upper substrate 20. On the upper substrate 20, the first and second scan electrodes Y1 and Y2 and the sustain electrodes X may be formed in parallel. Wall charges caused during the plasma discharge may be accumulated on the upper dielectric layer 22. The protective layer 24 may protect the upper dielectric layer 22 from being damaged by sputtering during the plasma discharge, and increase discharge efficient of secondary electrons. Magnesium oxide (MgO) may be used for the protective layer 24.

A lower dielectric layer 14 and partitions 16 may be formed on the lower substrate 10. The address electrodes A may be formed on the lower substrate 10. A fluorophore layer 18 may be coated on one side of the lower dielectric layer 14 and the partitions 16.

The partitions 16 may prevent ultraviolet rays and visible rays that are generated by the discharge from leaking to adjacent discharge cells. The fluorophore layer 18 may be excited by the ultraviolet rays generated during the plasma discharge, and emit any one of red, green, and blue visible rays. Inert gas mixture may be injected into the discharge cells enclosed by the upper substrate 20, the lower substrate 10 and the partitions 16.

In the PDP according to the first embodiment, a third bus electrode 38 included in each sustain electrode X may be positioned so as to overlap each partition 16. A third transparent electrode 40 included in each sustain electrode X may be positioned on two discharge cells. In such a case, each sustain electrode X is physically a single electrode, but two sustain electrodes X may be substantially driven. The details of this feature are described below. Meanwhile, each third bus electrode 38 may have a width equal to or narrower than that of each partition 16.

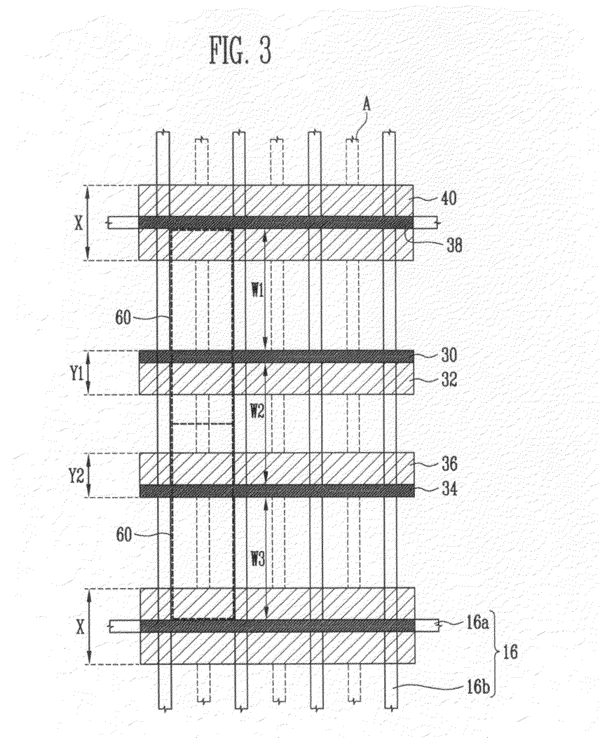

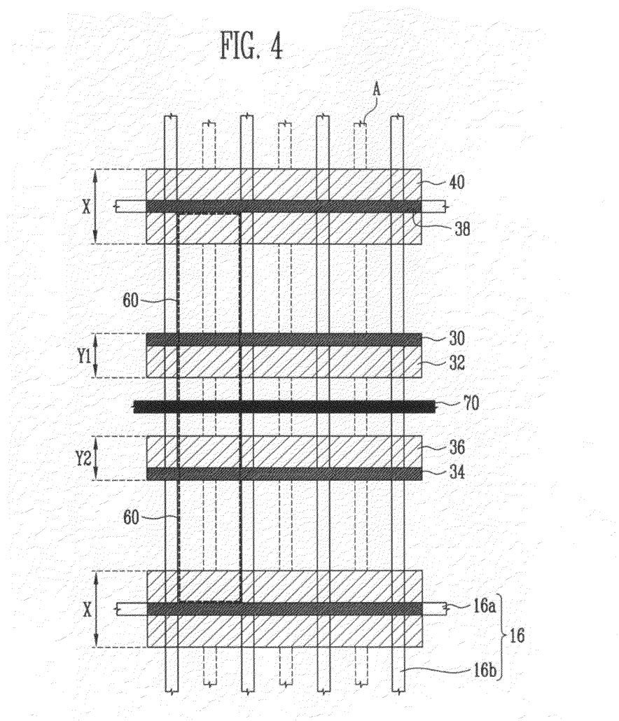

As illustrated in FIGS. 2 and 3, the first and second bus electrodes 30 and 34, may be positioned on the central region of each discharge cell 60. As such, when the first and second bus electrodes 30 and 34 are positioned on the central region of each discharge cell 60, the discharge voltage may be reduced.

According to the PDP of the first embodiment, a partition is not formed between the first and second scan electrodes Y1 and Y2. Therefore, the maximum discharge space may be obtained, and an address voltage and a sustain voltage may be reduced. In addition, since a partition is not formed between the first and second scan electrodes Y1 and Y2, priming charged particles generated by the address discharge of the first scan electrode Y1 may be fed to the second electrode Y2, and thus, the discharge voltage may be reduced and the discharge delay may also be reduced. Accordingly, the scan time required for the address discharge may be reduced, and thus sufficient driving time may be guaranteed.

Meanwhile, in the existing simple rectangular partition structure, all of the bus electrodes of the scan electrodes and the bus electrodes of the sustain electrodes are positioned on the discharge cell. However, according to the first embodiment, only the first and second bus electrodes 30 and 34 of the first and second scan electrodes Y1 and Y2 may be positioned on the discharge cells. Accordingly, a high aperture ratio may be obtained. In addition, according to the first embodiment, since a single sustain electrode X drives two discharge cells, a discharge space larger than that of the existing dual partition structure may be obtained.

FIG. 3 is a plan view illustrating the PDP illustrated in FIG. 2.

Referring to FIG. 3, sets of a first electrode Y1 and a second scan electrode and sustain electrodes X may be positioned alternately. Each address electrode may extend in a first direction. Each sustain electrode may extend in a second direction crossing to the first direction. Each first scan electrode Y1 and each second scan electrode Y2 may extend in the second direction.

The partitions 16 may include first partitions 16a and second partitions 16b. The first partitions 16a may be parallel to the scan electrodes Y1 and Y2 and the sustain electrodes X. The second partitions 16b may be parallel to the address electrodes A.

The second partitions 16b may be positioned alternately with the address electrodes A and distinguish the discharge cells 60. A first bus electrode 38 of each sustain electrode X overlaps each first partition 16a.

Meanwhile, according to the first embodiment, as illustrated in FIG. 3, a space that is positioned between first partitions 16a and above the central region between a first scan electrode Y1 and a second scan electrode Y2 may form a discharge cell 60. In addition, a space that is positioned between the first partitions 16a and below the central region between the first scan electrode Y1 and the second scan electrodes Y1 and Y2 may form a discharge cell 60.

According to the first embodiment, each sustain electrode X may cause sustain discharge with the first and second scan electrodes Y1 and Y2 that are positioned at upper and lower sides of each first partition 16a. That is, each sustain electrode X is physically a single electrode, but may cause the sustain discharge with the first scan electrode Y1 positioned at the lower side of each sustain electrode and the second scan electrode Y2 positioned at the upper side of each sustain electrode X. The third transparent electrodes 40 may have a width wider than those of the first and second transparent electrodes 32 and 34.

Meanwhile, the first, second, and third bus electrodes30, 34, and 38 may be sequentially disposed at an equal interval. Namely, a distance W1 between third and first bus electrodes 38 and 30, a distance W2 between first and second bus electrodes 30 and 34, and a distance W3 between second and third bus electrodes 34 and 38 may be made to be the same. When the distances W1, W2, and W3 are the same, the size of the discharge cells 60 may be made to be uniform. Accordingly, uniform brightness in the PDP may be achieved.

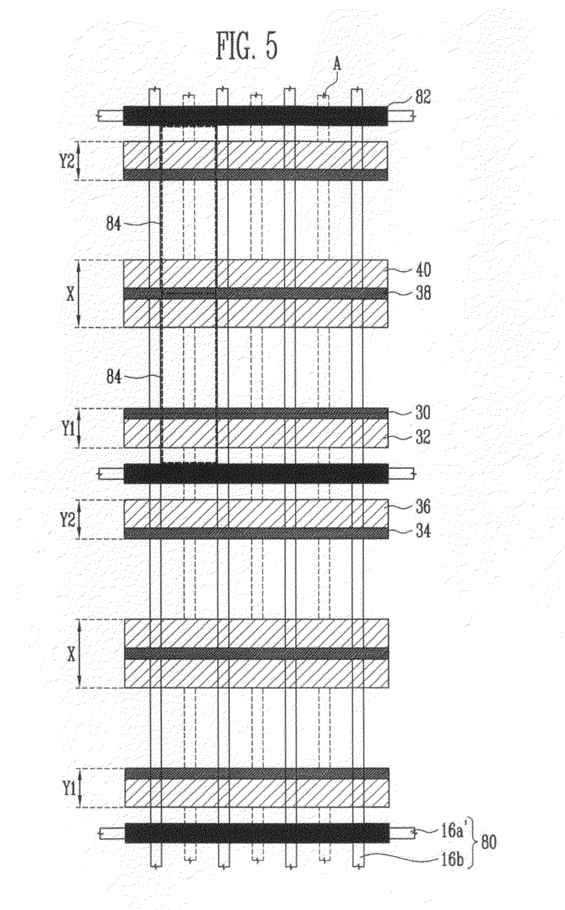

FIG. 4 is a plan view illustrating a PDP according to a second embodiment. In the description with reference to FIG. 4, the same reference numerals are assigned to the same elements as in FIG. 3, and any redundant description is omitted.

Referring to FIG. 4, a PDP according to the second embodiment may further include a black matrix 70 positioned in the central region between the first scan electrode Y1 and the second scan electrode Y2. Since the black matrix 70 may be positioned between a first scan electrode Y1 and a second scan electrode Y2, undesired light may be prevented from being emitted from the boundaries among the discharge cells 60.

FIG. 5 is a plan view illustrating a PDP according to a third embodiment. In the description with reference to FIG. 5, the same reference numerals are assigned to the same elements as in FIG. 2, and any redundant description is omitted.

Referring to FIG. 5, a PDP according to the third embodiment is different from the PDP according to the first embodiment as illustrated in FIG. 2 in view of the position of first partitions 16a′. That is, in the third embodiment, each first partition 16a′ may be positioned between a first scan electrode Y1 and a second scan electrode Y2.

According to the third embodiment, the sustain electrodes X may not overlap the first partitions 16a′. Each discharge cell 84 may be positioned between a first partition 16a′ above the central region of each sustain electrode X and a first partition 16a′ below the central region of each sustain electrode X, as illustrated in FIG. 5.

Each sustain electrodes X may cause sustain discharge with a second scan electrodes Y2 positioned above each sustain electrode X and with a first scan electrode Y1 positioned below each sustain electrode X, as illustrated in FIG. 5. Here, the sustain discharge may be determined according to whether the address discharge occurs or not. That is, according to the third embodiment, a single sustain electrode X may perform the sustain discharge with the scan electrodes Y2 and Y1 positioned above and below the sustain electrode X.

Meanwhile, in the third embodiment, priming charged particles may be generated by the address discharge between a second scan electrode Y2 and an address electrode A for an address period. The priming charged particles may be fed to a first scan electrode Y1. Accordingly, the address discharge delay may be minimized, and thus, the scan time may also be reduced.

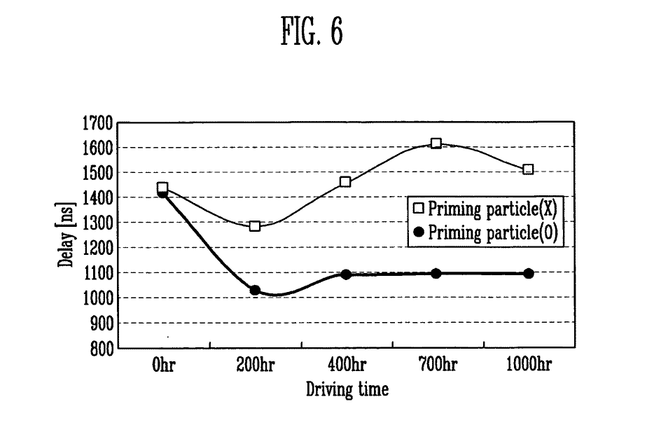

FIG. 6 is a graph presenting the relationship between the driving time and the address discharge delay according to the priming charged particles.

Referring to FIG. 6 and in accordance with the exemplary embodiments, the address discharge delay in feeding the priming charged particles is shorter than the address discharge delay in feeding no priming charged particle. For example, the address discharge in feeding the priming charged particles is shortened by 400 ns to 500 ns in comparison to the address discharge in feeding no priming charged particle. Therefore, according to the exemplary embodiments, the priming charged particles may be fed so that the scan time is shortened.

The exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate having a first side;
a second substrate having a second side facing the first side of the first substrate;
address electrodes, each extending in a first direction;
sustain electrodes, each extending in a second direction crossing the first direction;
sets of a first scan electrode and a second scan electrode, the sets and the sustain electrodes positioned alternately, each of the first and second scan electrodes having a line width narrower than a line width of each of the sustain electrodes;
first partitions, each extending in the second direction, each of the sustain electrodes overlapping each of the partitions; and
second partitions, each extending in the first direction, the second partitions and the address electrodes positioned alternately,
wherein each of the sets of the first scan electrode and the second scan electrode are positioned on a central region of a discharge cell, and
wherein the first scan electrodes, the second scan electrodes, and the sustain electrodes are formed on the second side of the second substrate, and address electrodes are formed on the first side of the first substrate.

2. The plasma display panel as claimed in claim 1, wherein each of the sustain electrodes causes sustain discharge with a first scan electrode positioned at a side of each sustain electrode and a second scan electrode positioned at the other side of each sustain electrode.

3. The plasma display panel as claimed in claim 1, wherein each of the sustain electrodes comprises:
a third transparent electrode; and
a third bus electrode positioned on a central region of the third transparent electrode.

4. The plasma display panel as claimed in claim 3, wherein each of the first bus electrodes overlaps each of the first partitions.

5. The plasma display panel as claimed in claim 3, wherein each of the third bus electrodes has a line width equal to or narrower than a width of each of the first partitions.

6. The plasma display panel as claimed in claim 3, wherein each of the first scan electrodes comprises:
a first transparent electrode having a line width narrower than a line width of each of the third transparent electrodes; and
a first bus electrode disposed on a first edge portion of the first transparent electrode, the first edge portion positioned at a side of a sustain electrode that is positioned at a side of each of the first scan electrode.

7. The plasma display panel as claimed in claim 6, wherein each of the second scan electrodes comprises:
a second transparent electrode having a line width narrower than a line width of each of the third transparent electrodes; and
a second bus electrode disposed on a second edge portion of the second transparent electrode, the second edge portion positioned at a side of a sustain electrode that is positioned at a side of each of the second scan electrode.

8. The plasma display panel as claimed in claim 7, wherein the first bus electrodes, the second bus electrodes, and the third electrodes are sequentially disposed at an equal interval.

9. The plasma display panel as claimed in claim 1, further comprising a black matrix formed between a first scan electrode and a second scan electrode in each of the sets.

10. A plasma display panel comprising:
a first substrate having a first side;
a second substrate having a second side facing the first side of the first substrate;
address electrodes, each extending in a first direction;
sustain electrodes, each extending in a second direction crossing the first direction;
sets of a first scan electrode and a second scan electrode, the sets and the sustain electrodes positioned alternately, each of the first and second scan electrodes having a line width narrower than a line width of each of the sustain electrodes;
first partitions, each extending in the second direction and positioned between the first scan electrode and the second scan electrode in each of the sets;
second partitions, each extending in the first direction, and the second partitions and the address electrodes positioned alternately,
wherein the first scan electrodes, the second scan electrodes, and the sustain electrodes are formed on the second side of the second substrate and address electrodes are formed on the first side of the first substrate

11. The plasma display panel as claimed in claim 10, wherein each of the sustain electrodes causes sustain discharge with a first scan electrode positioned at a side of each sustain electrode and a second scan electrode positioned at the other side of each sustain electrode.

12. The plasma display panel as claimed in claim 1, wherein each of the
sustain electrodes comprises:
a third transparent electrode; and
a third bus electrode positioned on a central region of the third transparent electrode.

13. The plasma display panel as claimed in claim 12, wherein the third bus electrode has line width equal to or narrower than a width of each of the first partitions.

14. The plasma display panel as claimed in claim 12, wherein each of the first scan electrodes comprises:
a first transparent electrode having a line width narrower than a line width of each of the third transparent electrodes; and
a first bus electrode disposed on a first edge portion of the first transparent electrode, the first edge portion positioned at a side of a sustain electrode that is positioned at a side of each of the first scan electrode.

15. The plasma display panel as claimed in claim 14, wherein each of the second scan electrodes comprises:
a second transparent electrode having a line width narrower than a line width of each of the third transparent electrodes; and
a second bus electrode disposed on a second edge portion of the third transparent electrode, the second edge portion positioned at a side of a sustain electrode that is positioned at a side of each of the second scan electrode.

16. The plasma display panel as claimed in claim 15, wherein the first bus electrodes, the second bus electrodes, and the third electrodes are sequentially disposed at an equal interval.

17. The plasma display panel as claimed in claim 10, further comprising a black matrix overlapping the first partitions.
